(19) United States
(12) Patent Application Publication
(10) Pub. No.: US 2011/0030410 A1
(43) Pub. Date: Feb. 10, 2011

(54) HOUSEHOLD APPLIANCE COMPRISING AN ANTI-JAMMING MECHANISM

(75) Inventors: Mehmet Ciyanoglu, Giengen (DE); Alexander Görz, Aalen (DE); Karl-Friedrich Laible, Langenau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 12/936,212

(22) PCT Filed: Apr. 6, 2009
(86) PCT No.: PCT/EP2009/054092

§ 371 Date: Oct. 4, 2010

(30) Foreign Application Priority Data
Apr. 17, 2008 (DE) 20 2008 005 332.3

(51) Int. Cl. F25D 23/00; B23P 19/00

(52) U.S. Cl. 62/331; 29/428

(57) ABSTRACT

A household appliance including a body; a door closing an interior compartment of the body and connected to the body by a hinge; an overlaid decorative plate that is distanced from the door by a gap; a covering element having a first limb that extends over a lateral wall of the body and a second limb that engages in the gap; and a first mounting part that is mounted in the gap on the overlaid decorative plate and that delimits a recess of at least one part of the second limb. The first mounting part has an abutment that defines a maximum depth up to which the second limb is introduced into the recess. A spacer is fixed on the first mounting part to enable mounting of the first mounting part at a distance from an edge of the overlaid decorative plate, wherein the distance is fixed by the spacer.

The present invention relates to the simplified assembly of an anti jamming mechanism on a household appliance, in particular a refrigeration appliance, with a body, to which is connected a door for closure of an interior compartment of the body and where the door is provided with an overlaid decorative plate distanced therefrom by a gap. Household appliances of this kind are employed in particular as built-in appliances, recessed into a furniture alcove, but also as large-format standalone appliances, which are set up closely adjacent to furniture units or other household appliances. The decorative plate generally blends into design elements of the adjacent furniture units or household appliances, in order to lend the arrangement an esthetically uniform appearance.

In the case of such an arrangement, it is generally seen as valuable that the front faces of the furniture units and the household appliances form a flush surface. In order to be able to open the door of such a household appliance, without adjacent furniture units or appliances being fouled, multilink hinges are mostly used, with which a movement of the door resembling rotation about an imaginary axis at a lateral distance from the body can be guided. A consequence of this guidance is that upon opening of the door, a gap arises between the hinge-side edge of the door and the front of an adjacent furniture unit or appliance, which can reach a width of several centimeters. A finger encroaching into this gap during closure of the door is at risk of sustaining a serious injury.

In order to obviate this risk of injury, the German patent application DE 10 2005 057 133 A1 proposes the realizing of an anti jamming mechanism for a built-in household appliance by means of a flexible covering element. The covering element hereby extends from a lateral wall of the body into a gap formed between the door of the household appliance and its overlaid decorative plate. It is there accommodated by connecting elements linking the hinge-side edge of the household appliance door and the decorative plate.

In a first embodiment, the covering element is held in a gap formed between the decorative plate and the connecting element linking the decorative plate with the door by means of a clamping force generating a friction lock, and by means of claws projecting into an insert groove. In a second embodiment it is proposed that the covering element be clamped between clamping jaws of the connecting element extending parallel to the decorative plate and a clamping piece.

In order to guarantee the secure protective effect of the covering element, a hinge must lie between a limb extending along the lateral wall and a limb of the covering element engaging in the gap between decorative plate and door close to an edge of the decorative plate. If this is not the case, the hinge must be retrospectively displaced. This is however extremely difficult, as the covering element blocks access to the insert groove in which it is clamped.

It is the object of the invention to create a household appliance of the kind specified above, in which incorrect location of the covering element is reliably prevented.

The object is achieved in that in a household appliance with a body and a door for closure of an interior compartment of the body connected to the body by means of a hinge, a decorative overlaid plate distanced from the door by a gap, a covering element, comprising a first limb extending over a lateral wall of the body and a second limb engaging in the gap, and at least one first mounting part mounted in the gap on the decorative plate, which delimits a recess of at least part of the second limb, the first mounting part has an abutment, which defines a maximum depth to which the second limb can be introduced into the recess, and that at least one spacer can be fixed on the mounting part, in order to enable the mounting of the mounting part at a distance from an edge of the decorative plate fixed by the spacer. Thus through the use of the spacer in the mounting of the first mounting part on the decorative plate, the position of the abutment in relation to the edge is fixed, and the installation position of the covering element is clear and correctly determined, without the need to take measurements.

The distance to the edge of the decorative plate and the abutment fixed by the spacer are preferably so harmonized that when the second limb is introduced into the recess as far as the abutment, a connecting element, in particular a foil hinge, runs at a predefined distance along the edge of the decorative plate between first limb and second limb of the covering element.

In an embodiment enabling particularly simple mounting, the first mounting part has a bridge section between the supporting surfaces touching the decorative plate, connecting the supporting surfaces, and at a distance from the decorative plate, which—preferably together with the decorative plate—delimits the recess for the second limb of the covering element.

In this embodiment the abutment can be formed by an edge, preferably an edge facing the edge of the decorative plate, at least of one of the supporting surfaces.

In that a tongue of the second limb extending through the recess bears on its free end a first projection, which engages behind one of the supporting surfaces, a form-fitted engagement of the covering element on the first mounting part can be achieved. The projection is preferably directed downwards, so that the engagement is secured by means of the weight of the covering element.

If the tongue bears a second projection on its free end, which extends in the opposite direction to the first projection, the covering element can be anchored just as securely to a door with right-hand hinging as to a door with left-hand hinging.

A projection of the bridge section facing the decorative plate can be latched into a notch of the tongue, in order to secure the covering element additionally on the first mounting part.

It is further expedient that the first mounting part has a bridge section between the supporting surfaces touching the decorative plate, connecting the supporting surfaces, and at a distance from the decorative plate which—preferably together with the decorative plate—delimits a recess for a second limb of an angled second mounting part, of which a first limb is attached to a lateral flank of the door.

The spacer fixed onto the first mounting part can advantageously also serve to couple the mounting parts to each other, so that they cannot come loose from each other during mounting of the decorative plate on the door.

The spacer should be fixed to the mounting parts in a releasable manner, so that it can be removed after completed assembly of the decorative plate.

To serve as a reference for orientation of the first mounting part on the decorative plate, the spacer preferably has a first abutment surface for abutment to an outer edge of the decorative plate and a second abutment surface parallel to the first abutment surface for abutment to the first mounting part.

In order to simplify construction of the first mounting part with the decorative plate, the spacer and the first mounting part preferably have releasably interacting latching means for fixing of the spacer to the first mounting part at least in a direction perpendicular to the abutment surfaces. The spacer is preferably manufactured from elastic plastic material or hard rubber, so that it behaves with sufficient flexibility that it can be latched by hand without the use of tools and—after mounting of the first mounting part on the decorative plate—unlatched again.

Fixing of the spacer is also served by the fact that this preferably has fingers which grip a bracket of the first mounting part on opposite sides and bear the second abutment surface.

The bracket preferably also serves to hold a connecting tongue embodied on the second mounting part, that is the bracket serves simultaneously to anchor the spacer and for connection with the second mounting part.

The fingers of the spacer enclosing the bracket can also be used to fix the connecting tongue—and via it the whole second mounting part—vertically in relation to the first mounting part. If the spacer is removed after mounting of the decorative plate on the door, this fixing does not apply, and the decorative plate is vertically movable for adjustment purposes.

In order to achieve vertical fixing, the connecting tongue preferably extends into a space between two of the fingers enclosing the bracket, which run on a same side of the brackets as the connecting tongue.

Further features and advantages of the invention are evident from the following description of exemplary embodiments, with reference to the attached figures, wherein:

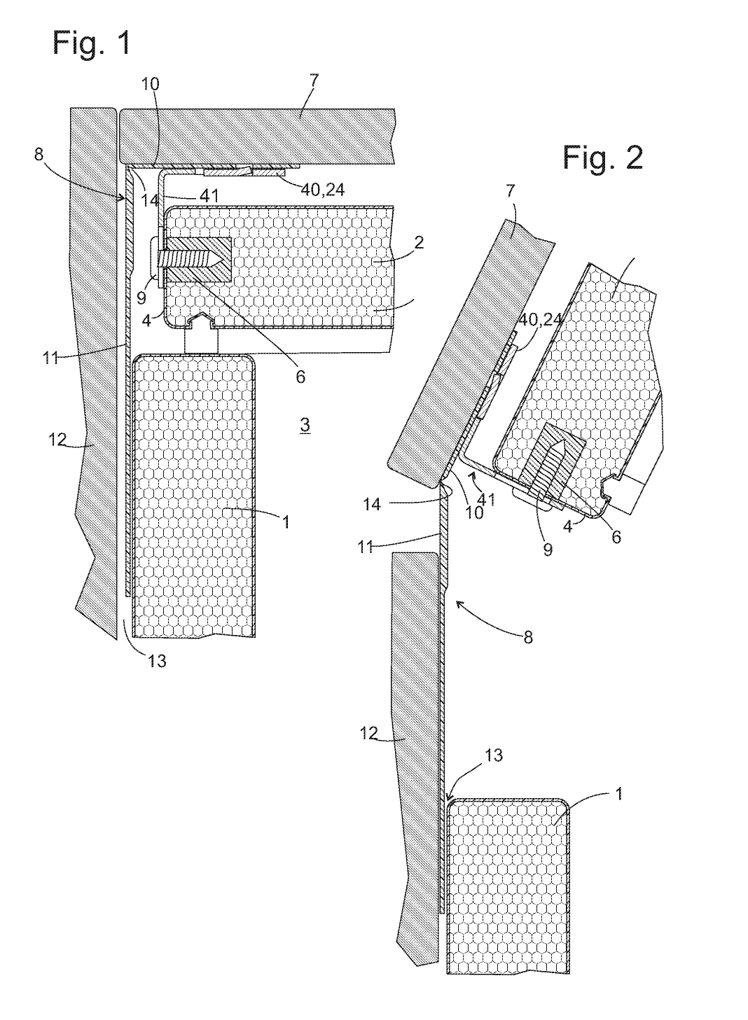

FIG. 1 shows a partial section through the housing of a built-in refrigeration appliance and surrounding furniture units, with a closed door;

FIG. 2 shows a section similar to FIG. 1 with an open door;

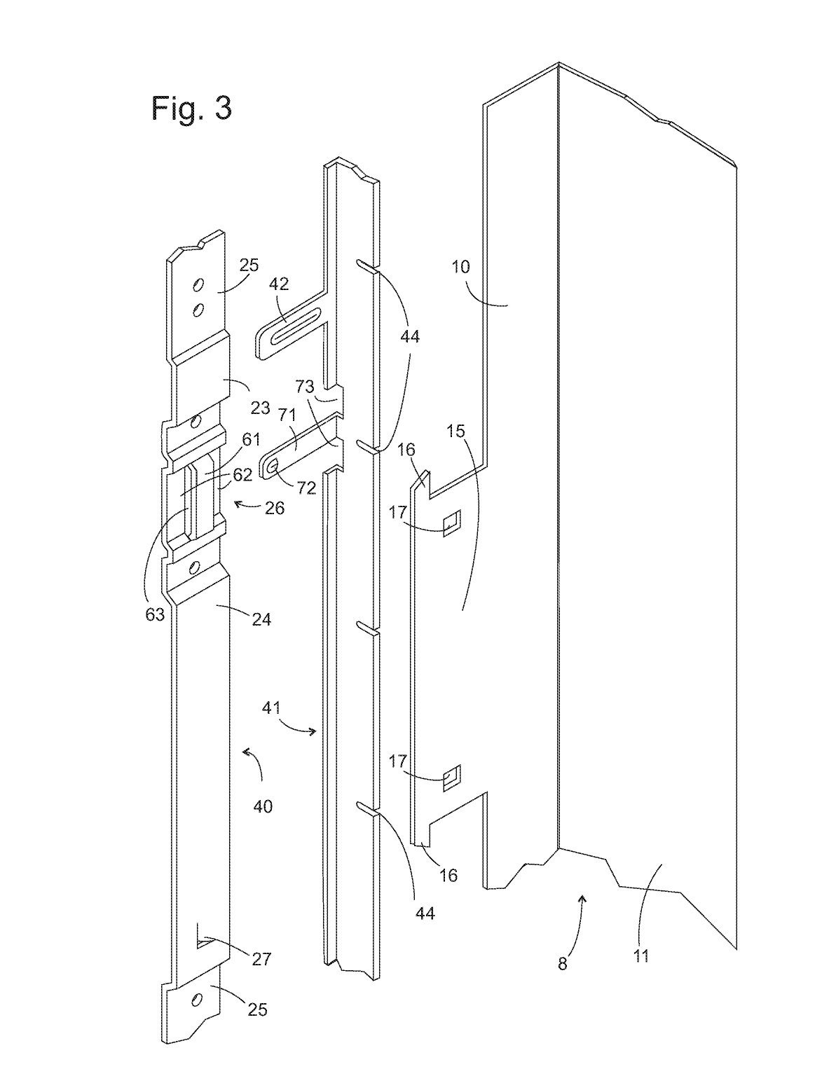

FIG. 3 shows a bridging strip, an angled fixing strip and a covering element for connection of the door of the refrigeration appliance with the decorative plate, in a three-dimensional partial view;

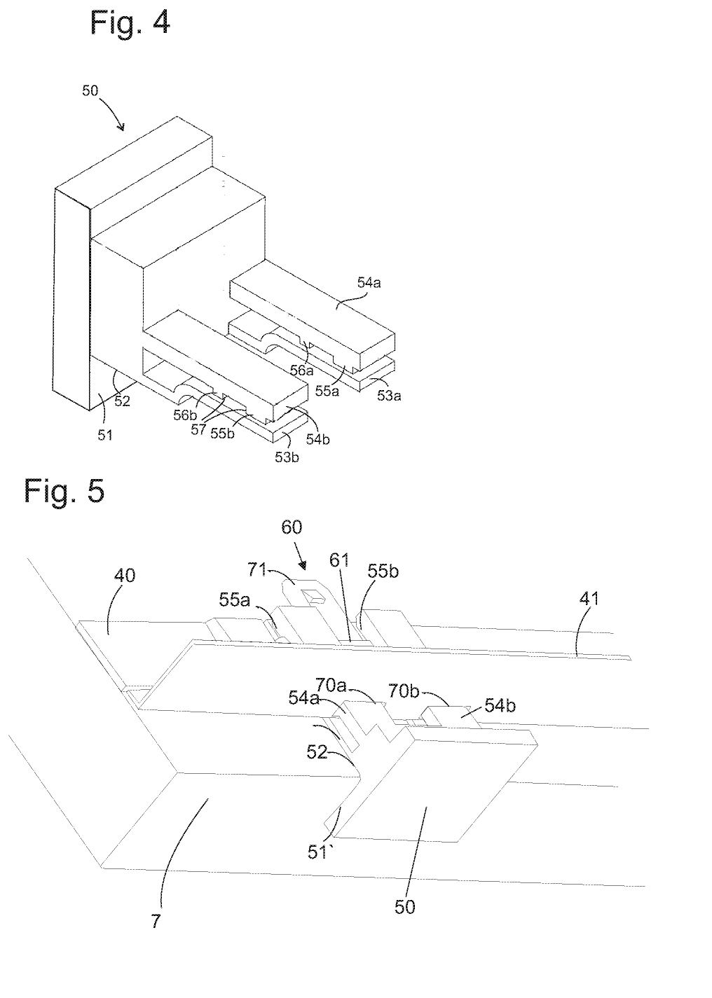

FIG. 4 shows a three-dimensional view of a spacer;

FIG. 5 shows a view of the bridging strip and angled fixing strip connected to each other with the aid of the spacer; and

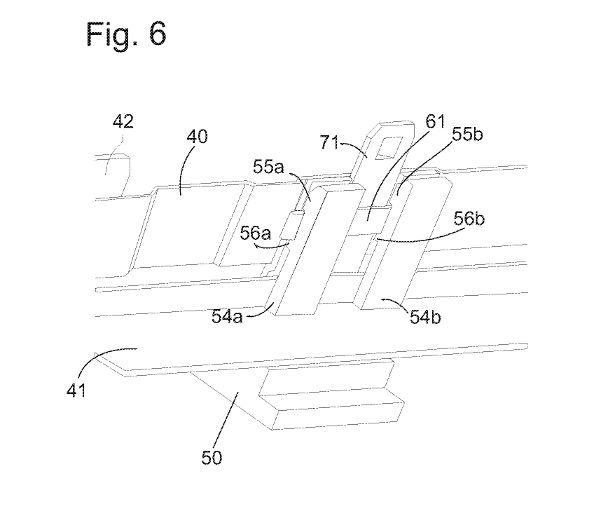

FIG. 6 shows a second view of the connected bridging strip and angled fixing strip.

FIG. 1 shows a diagrammatic section through a front corner of a built-in refrigeration appliance housing, installed in a furniture alcove. The housing comprises, in the customary manner, a body 1 and a door 2, which enclose an interior compartment 3 and which are realized as a hollow body filled with insulating material. Distributed in a lateral flank 4 of the door 2 are tapped blind holes 6, of which one is shown in sectional form. Screws 9 held in the tapped blind holes 6 carry an angled fixing strip 41. A limb of the angled fixing strip 41 extending in front of the front face of the door 2 engages with a bridging strip 40 in a manner described more precisely below, in order to carry a decorative plate 7 of the door 2. An elongated angled covering element 8 has a first limb 10, which is held on the rear face of the decorative plate 7, between this and the bridging strip 40, and a second limb 11, which extends along a lateral wall 12 of the furniture alcove, and engages in a gap 13 between the lateral wall 12 and the body 1.

If the door of the refrigeration appliance is to be opened, the decorative plate 7 must move outwards from the furniture alcove, as shown in the section of FIG. 2. Here, the covering element 8 is bent at a foil hinge 14 connecting the two limbs 10, 11, and the second limb 11 slides forwards out of the gap 13, in order to block a gap arising between the hinge-side edge of the decorative plate 7 and the lateral wall 12.

FIG. 3 shows a three-dimensional partial view of the bridging strip 40, the angled fixing strip 41 and of the covering element 8. The bridging strip 40 is a metal strip more deeply structured by means of cranked steps, which is provided to be screwed on the rear face of the decorative plate 7 adjacent to a lateral edge. Offset from each other by means of the cranked steps, supporting surfaces 25, 26 and bridge sections 23, 24 alternate in the longitudinal direction of the bridging strip 40. In the assembled state, the supporting surfaces 25, 26 abut the decorative plate 7; the bridge sections 23, 24 delimit in each case together with the decorative plate gaps open to the side. In the bridge sections 24, a tab 27 is in each case punched out in a lower area and notched out obliquely into the gap between the bridge section 24 and the decorative plate 7.

While the supporting surfaces 25 are essentially flat, a detent bracket 61 flanked by edge strips 62 is in each case punched out and notched from the supporting surfaces 26.

In each case at least two of the supporting surfaces 26 and the bridge sections 23, 24 are present on the bridging strip 40.

The angled fixing strip 41 is an angular profile with two mutually orthogonal limbs, of which the first extends in the assembled state parallel to the rear face of the decorative plate 11 and the second abuts the lateral flank 4 of the door and is held by the screws 9. The first limb has a multiplicity of tongues 42, which are provided to engage in the gaps between the bridge sections 23 and the decorative plate 7, when the bridging strip 40 is fixed onto the decorative plate 7, and detent tongues 71, which are provided to engage in a space 63 that lies between one of the detent brackets 61 and its adjacent strips 62. The edge strips 62 running between the detent tongues 71 and the decorative plate 7 hold the angled fixing strip 41 at a distance from the decorative plate 7.

The detent tongues 71 in each case bear a latch 72 on their tip, which is provided

to latch in the space 63 behind the edge of the detent bracket 61 facing away from the edge of the decorative plate 7 after insertion of the detent tongue 71, and thus to prevent the two mounting parts 40, 41 coming loose from each other again. The length of the detent bracket 61 is significantly greater than the width of the detent tongue 71, so that if the detent tongue 71 alone engages in the space 63, it can be displaced in the longitudinal direction of the bridging strip 40, that is to say vertically, if the mounting parts 40, 41 are mounted.

Slots 44 shown on the second limb are provided, in order to push them onto the screws 9 initially loosely inserted into the lateral flank 4 of the door 2 and thus to hold the decorative plate 7 with the mounting parts 40, 41 on the door 2, initially in a loose manner and adjustably in the depth direction of the refrigeration appliance.

As FIG. 3 further shows, the first limb 10 of the covering element 8 abutting the decorative plate 7 has at each bridge section 24 of the bridging strip 40 a projecting tongue 15, from the free end of which projections 16 protrude upwards and downwards. The distance between the tips of the projections 16 facing away from each other is slightly smaller than the length of the bridge section 24, so that the tongue 15 can be inserted from the side between the bridge section 24 and the decorative plate 7. The angled fixing strip 41 does not prevent the insertion of the tongue 15, as a gap is kept free between it and the decorative plate 7 by means of the edge strips 62.

After insertion of the tongue 15 between the bridge section 24 and the decorative plate 7, the entire covering element 8 is displaced downwards, so that the lower projection 16 of the tongue 15 engages behind the supporting surface 25 bordering the bridge section 24 below. The length of the tongue 15 is so dimensioned that as a result of this engagement the position of the limb 10 in the width direction of the decorative plate 7 is fixed with to-the-millimeter precision, subject to a small degree of play.

By means of the downward displacement of the covering element 8 the inwardly bent tab 27 of the bridge sections 24 comes into engagement with a lower opening 17 of the tongue 15. Although initially an asymmetrical contour of the tab 27 enables the tongue 15 to be pushed past the tip of the tab 27 into the through-access and subsequently to descend, it then prevents an upward movement of the tongue 15, so that the covering element 8 is locked in the vertical direction too.

For attachment of the decorative plate 7 to the door 2 in each case two mirror-image bridging strips 40 and angled fixing strips 41 are provided, which are mounted on both lateral flanks 4 of the door 2. As the covering element 8 has on its tongues 15 in each case two projections 16 and two openings 17 in a mutually mirror-symmetrical arrangement, it can be introduced between the door 2 and the decorative plate 7 from both the right and the left and latched onto the respectively adjacent bridging strip 40. Accordingly, the covering element 8 can be used both with right-hinged and left-hinged doors.

For the effectiveness of the anti-jamming mechanism to be realized with the covering element 8 it is important that its foil hinge 14 comes to rest precisely on the edge of the decorative plate 7. Serving this purpose among others, is a spacer 50, shown in a three-dimensional view in FIG. 4. The spacer 50 has a base plate with an abutment surface 51, which is provided to abut the lateral edge of the decorative plate 7. A block 52 of the spacer 50 protruding over the abutment surface 51 has a surface seen at the bottom in FIG. 3, which during assembly abuts the rear face of the decorative plate 7. From the block 52 project two pairs of gripper fingers, 53a, 54a or 53b, 54b respectively, separated in each case by a space of the width of the detent tongues 71. In the assembled state these gripper fingers extend through notches 73 (see FIG. 2) formed in the angled fixing strip 41 on both sides of the detent tongues 71, and engage in the space 63 above and below the detent tongue 71.

The fingers 53a, 53b have a cranked form, in order to facilitate negotiation of the edge strip 62 and insertion into the space 63.

The gripper fingers 54a, 54b lying opposite the fingers 53a, 53b in each case bear two latches 55a, 56a or 55b, 56b respectively, which in the assembled state of the spacer 50 enclose the detent bracket 61 on both sides without play. Lateral flanks of the latches 55a, 56a, 55b, 56b thus form abutment surfaces 57, which define the distance of the bridging strip 40 from one edge of the decorative plate 7, when the abutment surface 51 of the spacer 50 abuts this edge.

A mounting structure for mounting of the decorative plate 7 comprises in each case two of the bridging strips 40 and angled fixing strips 41 shown in FIG. 3, a covering element 8 and a number of spacers 50, at least four, corresponding to the number of detent tongues 71 of the angled fixing strips 41.

A first assembly step is the insertion of the detent tongues 71 on the angled fixing strip into the spaces 63 of the supporting surfaces 26 of the associated bridging strip, so that the latches 72 lock on the far side of the detent brackets 61. In this state the bridging strips 40 and the angled fixing strips 41 can in each case be displaced against each other in their longitudinal direction.

Next, the spacers 50, in each case with their gripper fingers 53, 54 in front, are pushed through the notches 73 on both sides of the detent tongues 71 and into the space 63 on each side of one of the detent tongues 71. The mounting parts 40, 41 are thereby also fixed relative to each other in their longitudinal direction. FIGS. 5 and 6 show two three-dimensional views of the inserted spacers 50.

The two mirror-image assemblies, in each case comprising a bridging strip 40, an angled fixing strip 41 and two spacers 50 are laid on the rear face of the decorative plate 7 along its lateral edges in such a way that the abutment surfaces 51 of the spacers 50 strike the edges of the decorative plate 7. The bridging strips 40 are now screwed onto the decorative plate 7 at the height of the supporting surfaces 25, 26. An adjustment rail, for example as known from DE 10 2005 021 607 A1, is further screwed onto the rear face of the decorative plate.

In the assembly thus created, comprising decorative plate 7, mounting parts 40, 41, adjustment rail and spacers 50, all parts are fixed relative to each other. In this state, the complete assembly can be provisionally suspended on the door 2, in that as already mentioned, the slots 44 of the angled fixing strips 41 are pushed onto screws 9 inserted into the lateral flanks 4 of the door. A protruding limb of the adjustment rail thereby comes to rest on screws engaging in an upper flank of the door.

The position of the decorative plate 7 can now be directly adjusted in the depth direction and the screws subsequently tightened in the lateral flanks 4 of the door 2; it is also conceivable initially to tighten these screws temporarily, and to carry out a depth adjustment at a later point in time.

After the angled fixing strips 41 are fixed to the lateral flanks 4 by tightening the screws 9, the spacers 50 are removed. Through withdrawal of the spacers 50, the decorative plate 7 is once more vertically adjustable. Vertical fine adjustment can now be carried out, if necessary, with the aid of the screws supporting the adjustment strip.

By means of the preceding removal of the spacers 50, the gap between the decorative plate 7 and the angled fixing strip 41 is open over its entire length and ready to accommodate the limb 10 of the covering element 8. By means of the dimensioning of the spacer 50, in particular of the distance between the abutment surfaces 51 and 57, it is ensured that the limb 10 then strikes the bridging strip 40 precisely when the foil hinge 14 of the covering element 8 lies at the height of the edge of the decorative plate 7. In that the covering element 8 is now displaced slightly downwards, the upward-pointing projections 16 on its tongues 15 are brought into form-fitted engagement on the side of the bridging strip 40 facing away from the edge of the decorative plate 7, and the tabs 27 latch into the lower openings 17 of the tongues 15. The covering element 8 is thus not only clamped between the decorative plate 7 and the door 2, but also locked in place by means of form-fitted engagement, and protected against slippage, so that lasting effectiveness of the anti-jamming mechanism is guaranteed.

1-18. (canceled)

19. A household appliance, comprising:
a body having a lateral wall;
a hinge;
a door to close an interior compartment of the body, the door connected to the body by the hinge;
an overlaid decorative plate distanced from the door by a gap;
a covering element having a first limb that extends over the lateral wall of the body and a second limb that engages in the gap; and
a first mounting part mounted in the gap on the overlaid decorative plate, the first mounting part delimiting a recess of at least one part of the second limb;
wherein the first mounting part has an abutment that defines a maximum depth up to which the second limb is introduced into the recess; and
wherein a spacer is fixed on the first mounting part to enable mounting of the first mounting part at a first distance from an edge of the overlaid decorative plate, the distance being fixed by the spacer.

20. The household appliance of claim 19, wherein the household appliance is a household refrigeration appliance.

21. The household appliance of claim 19, wherein the first distance to the edge of the overlaid decorative plate and the abutment are harmonized such that, when the second limb is introduced into the recess up to the abutment, a connecting element between first limb and second limb of the covering element runs for a predefined distance along the edge of the overlaid decorative plate.

22. The household appliance of claim 21, wherein the connecting element is a foil hinge.

23. The household appliance of claim 19, wherein the first mounting part has a bridge section between supporting surfaces that touch the overlaid decorative plate, the bridge section connecting the supporting surfaces and arranged at a second distance from the overlaid decorative plate; and wherein the bridge section delimits the recess for the second limb of the covering element.

24. The household appliance of claim 23, wherein the abutment is formed by an edge of at least one of the supporting surfaces.

25. The household appliance of claim 23, wherein the second limb has a tongue that extends through the recess, and wherein a free end of the tongue bears a first projection that engages behind one of the supporting surfaces.

26. The household appliance of claim 25, wherein the free end of the tongue bears a second projection that extends in the opposite direction to the first projection.

27. The household appliance of claim 25, wherein the bridge section has a third projection facing the overlaid decorative plate, and wherein the third projection is latched into a notch of the tongue.

28. The household appliance of claim 23, further comprising an angled second mounting part, wherein the bridge section delimits a recess for a second limb of the angled second mounting part, and wherein a first limb of the angled second mounting part is attached to a lateral flank of the door.

29. The household appliance of claim 28, wherein the spacer locks the first mounting part and the angled second mounting part together.

30. The household appliance of claim 29, wherein the spacer is attached to the first mounting part and the angled second mounting part in a releasable manner.

31. The household appliance of claim 19, wherein the spacer has a first abutment surface for abutment to an outer edge of the overlaid decorative plate and a second abutment surface parallel to the first abutment surface for abutment to the first mounting part.

32. The household appliance of claim 31, wherein the spacer and the first mounting part have releasably interacting latching means to fix the spacer to the first mounting part at least in a perpendicular direction to the first and second abutment surfaces.

33. The household appliance of claim 32, wherein the spacer has fingers that enclose a bracket of the first mounting part on opposite sides and that bear the second abutment surface.

34. The household appliance of claim 33, further comprising a second mounting part, wherein the bracket holds a connecting tongue on the second mounting part.

35. The household appliance of claim 34, wherein the connecting tongue is vertically fixed by the fingers.

36. The household appliance of claim 35, wherein the connecting tongue extends in a space between two of the fingers that run on the same side of the bracket as the connecting tongue.

37. A method for mounting of a decorative plate on a household appliance, the method comprising:
mounting a mounting part on the decorative plate at a distance from an edge of the decorative plate, the distance fixed by a spacer;
attaching the decorative plate on a door of the household appliance; and
introducing a covering element into a gap between the decorative plate and the door up to an abutment on the mounting part.

38. The method of claim 37, wherein the spacer is removed after attaching the decorative plate and before introducing the covering element.
